(19) United States
(12) Patent Application Publication
(10) Pub. No.: US 2024/0192085 A1
(43) Pub. Date: Jun. 13, 2024

(54) DEVICE FOR DETERMINING UPDATED STATISTICAL LIFE OF A BEARING, AND ASSOCIATED DEVICE AND WIND TURBINE

(71) Applicant: Aktiebolaget SKF, Göteborg (SE)

(72) Inventors: Mourad CHENNAOUI, Amsterdam (NL); Mohamad AMIN AL HAJJ, Utrecht (NL); Johannes SCHIRMER, Oberhohenried (DE); Albrecht NESTLE, Bamberg (DE); Sebastien BLACHERE, Den Haag (NL); Guillermo Enrique MORALES ESPEJEL, Ijsselstein (NL)

(21) Appl. No.: 18/527,545

(22) Filed: Dec. 4, 2023

(30) Foreign Application Priority Data
Dec. 12, 2022 (DE) 102022213423.0

(51) Int. Cl. G01M 13/04; F03D 17/00

(52) U.S. Cl. CPC G01M 13/04; F03D 17/032

(57) ABSTRACT

A device (7) for determining updated statistical life value of a bearing (5) in a machine (1). The device includes a rating life model (MODEL) of the bearing (5), a first determining means (8), and a second determining means (9). The first determining means (8) determines momentary life rating values from values of at least one parameter representative of the condition of use of the bearing in the machine and the rating life model (MODEL). The second determining means (9) determines the updated statistical life value from the momentary life rating values.

### CROSS-REFERENCE TO RELATED APPLICATION

This application claims priority to German Application No. 102022213423.0, filed Dec. 12, 2022, the entirety of which is hereby incorporated by reference.

### FIELD

The present disclosure is directed to the determination of life rating of bearings, and more particularly to the determination of updated statistical life of a bearing in a machine.

The present disclosure is also related to a device for determining the updated statistical life and a wind turbine comprising such a device.

### BACKGROUND

Rating life calculation of a bearing is generally based on assumed or estimated application conditions and load cycles.

However, the actual application conditions could deviate significantly from the assumed application conditions and load cycles leading to bearing failures and unplanned downtime.

### SUMMARY

Consequently, the present disclosure intends to take into account the conditions of use of the bearing in the machine to determine the life rating of the bearing.

According to an aspect, a method for determining updated statistical life value of a bearing in a machine is proposed.

The method comprises: determining momentary life rating values from values of at least one parameter representative of the conditions of use of the bearing in the machine and from a rating life model of the bearing, and determining the updated statistical life value from the momentary life rating values.

The updated statistical life is an indicator permitting to compare application conditions in operation to initially assumed or estimated application conditions and thus to identify critical application conditions, which might lead to damages or accelerated damage accumulation, in order to increase the operating time of the bearing and reduce unplanned downtime of the machine.

Preferably, the method further comprises determining an operation life indicator equal to the first reference updated statistical life value divided by a first reference updated statistical life value to determine the extent of bearing damage.

Advantageously, the values of the at least one parameter are represented by a temporal continuous signal, determining momentary life rating values comprises: sampling each temporal continuous signal, each sampled temporal continuous signal being defined by a series of successive sampling intervals, determining a discrete value for each sampling interval of each sampled temporal continuous signal, and for each sampling interval, determining the momentary life rating value from the discrete value of the said sampling interval of each sampled temporal continuous signal and the rating life model.

Preferably, if the sampling intervals of the series of successive sampling intervals of each sample temporal continuous signal have not the same length, the method further comprises weighting each momentary life rating value according to the length of the sampling interval associated to the said momentary life rating value.

Advantageously, the method further comprises: determining a first sub updated statistical life value, the first sub updated statistical life value being equal to the updated statistical life value determined over a first temporal interval having a predetermined length, and comparing the first sub updated statistical life value to a second reference updated statistical life to determine the relative degree of accumulated damage of the bearing.

Advantageously, the method further comprises: determining a first sub updated statistical life value, the first sub updated statistical life value being equal to the updated statistical life value determined over a first temporal interval having a predetermined length, determining at least a second sub updated statistical life value, the second sub updated statistical life value being equal to the updated statistical life value determined over a second temporal interval having the predetermined length, the second temporal interval being subsequent to the first temporal interval, and comparing the first sub updated statistical life value and the second sub updated statistical life value to determine the relative degree of accumulated damage of the bearing.

Preferably, if at least one momentary life rating value determined from values of the parameter and the rating life model is outside of its domain of applicability, the bearing is considered as defective.

In this case, inspection, maintenance or other measures to prevent unplanned machine downtime could be initiated.

According to another aspect, a device for determining updated statistical life value of a bearing in a machine is proposed.

The device comprising: a rating life model of the bearing, first determining means configured to determine momentary life rating values from values of at least one parameter representative of the condition of use of the bearing in the machine and the rating life model, and second determining means configured to determine the updated statistical life value from the momentary life rating values.

According to another aspect, a wind turbine comprising a bearing and a device defined above is proposed.

### BRIEF DESCRIPTION OF THE DRAWINGS

Other advantages and features of the present disclosure will appear on examination of the detailed description of embodiments, in no way restrictive, and the appended drawings in which:

FIG. 1 illustrates schematically a rotating machine according to the present disclosure;

FIG. 2 illustrates schematically an example of a method determining updated statistical life of a bearing in the machine according to the present disclosure.

### DETAILED DESCRIPTION

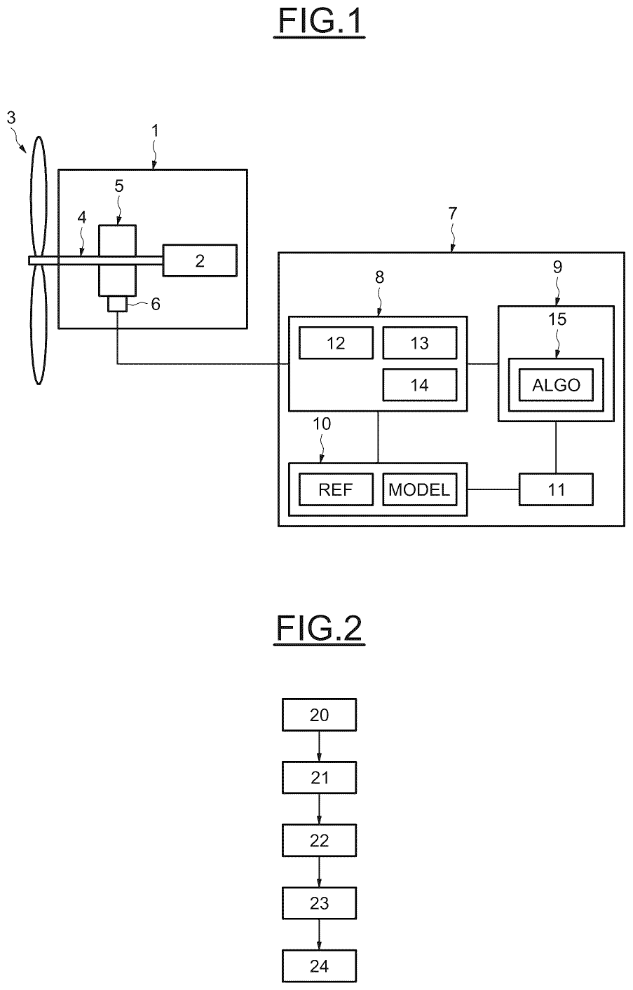

Reference is made to FIG. 1 which represents schematically a rotating machine 1.

The machine 1 may be a wind turbine comprising a generator 2, a propeller 3, a shaft 4 connecting a shaft of the generator 2 to the propeller 3, and a bearing 5 supporting the shaft 4.

The machine 1 further comprises a sensor 6 to measure values of a parameter representative of the condition of use of the bearing 5 in the wind turbine.

The sensor 6 may a load sensor measuring the load acting on the bearing 5 and delivering a temporal continuous signal comprising the load values.

The sensor 6 is connected to a device 7 intended to determine updated statistical life values of the bearing 5.

The device 7 comprises first determining means 8 and second determining means 9.

The device 7 further comprises a memory 10 and comparison means 11.

The memory 10 saves a rating life model MODEL and a first reference updated statistical life value REF.

The first determining means 8 receive the temporal continuous signal delivered by the sensor 6 and is intended to determine momentary life rating values from the load values and the rating life model MODEL.

The first determining means 8 comprise sampling means 12, averaging means 13, and computation means 14.

The second determining means 9 are intended to determine the updated statistical life value from the momentary life rating values delivered by the first determining.

The second determining means 9 comprise second computation means 15 implementing a Palmgren-Miner rule algorithm ALGO.

A rating life model is a deterministic model, which determines, based on input of application data, the number of revolutions done by one of two rings rotating concentrically of the bearing or washers of the bearing in relation to the other ring or washer before the first evidence of fatigue develops in the material of one of the two rings or in the material of one of the washers or in the material of one of the rolling elements.

As an example for the MODEL, the basic rating life model, defined in ISO 281, comprises a relationship between the load value P (application data) and the momentary life rating value L₁₀ᵢ of an interval i, the relationship being equal to:

$${L}_{10 {i}_{i}} = {( \frac{C}{P} )}^{p}$$

where:
L₁₀ᵢ: the basic rating life at 90% probability in millions of revolutions
C: the dynamic load rating in kN
P: the equivalent dynamic bearing load in kN determined by the sensor 6
p: a geometrical constant (3 for ball bearings, 10/3 for roller bearings).

The first reference updated statistical life value REF is referenced L_{10,REF}.

In variant, the rating life model MODEL may take into account more than one parameter representative of the conditions of use of the bearing. The rating life model MODEL may for example take into account one or more of the load distribution acting on the bearing, the centrifugal loads acting on the bearing, lubrification condition of the bearing, contamination of the bearing, clearance and preload of the bearing, misalignment and moment load, profiles and form deviations of the bearing.

The rating life model MODEL may for example comprise a stress-based Generalized Bearing Life Model (GBLM) or an Advanced Fatigue Calculation Model (AFC).

The first reference updated statistical life value L_{10,REF} is equal to the expected number of load cycles or operating time after which ten percent of the bearings in that application can be expected to have failed due to a failure mode, predicted by the rating life model MODEL. It is the operation time after which a given percentile of a bearing population will still be operating.

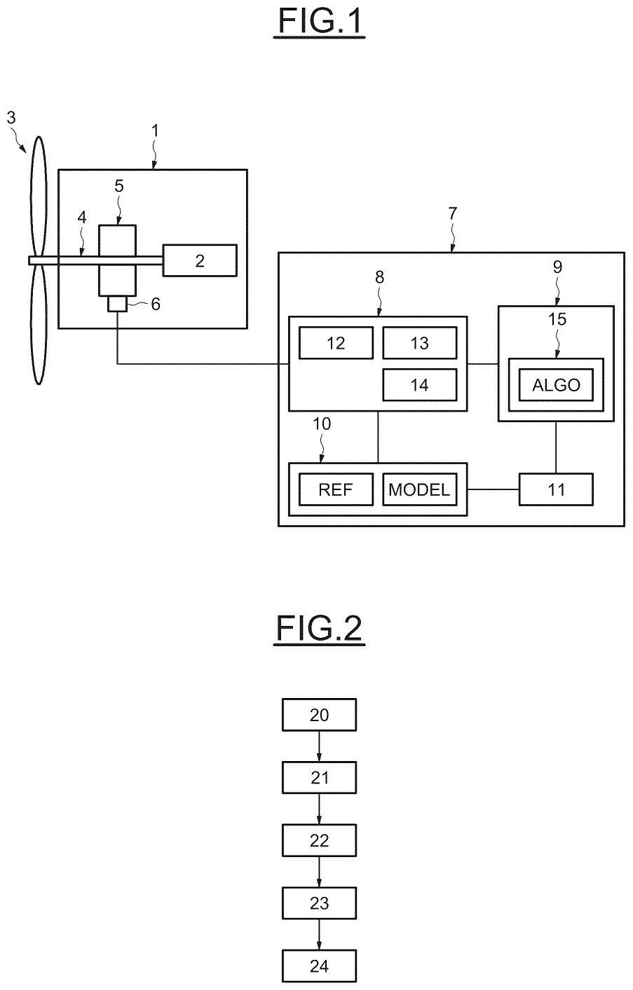

FIG. 2 illustrates schematically an implementation of the device 7.

The device 7 determines momentary life rating values from values of the loads acting on the bearing 5 measured by the sensor 6 and the rating life model MODEL (steps 20 to 22).

The device 7 than determines the updated statistical life value L_{10,USL} from the momentary life rating values (step 23).

During a step 20, the sampling means 12 sample the signal delivered by the sensor 6 to obtain series of successive sampling intervals.

During a step 21, a discrete value is determined, for example a mean value for each sampling interval of the sampled signal.

The averaging means 13 determine the mean value for each sampling interval of the sampled signal.

During a step 22, for each sampling interval i, the computation means 14 determine the momentary life rating value L₁₀ᵢ from the mean value of the said sampling interval 1 and the rating life model MODEL.

The momentary life rating value of each sampling interval is transmitted to the second determining means 9.

During a step 23, the second computation means 15 implement the Palmgren-Miner rule algorithm ALGO to determine the updated statistical life value L10h.

$$L 10 h = \frac{1}{{\sum }_{j} \frac{{U}_{j}}{{L}_{10 {i}_{j}}}}$$

Where:
j: index for each load case
Uⱼ: duty cycle (percentage of occurrence of load case)

If the sampling intervals have not the same length, the momentary life rating values L₁₀ᵢ are weighted according to the length of the sampling interval associated to the said momentary life rating value to determine the updated statistical life value L10h.

During a step 24, the comparison means 11 compare the updated statistical life value L10h to the first reference updated statistical life value REF to determine the degree of stress of the bearing.

If the updated statistical life value is lower than the first reference updated statistical life value, the bearing has accumulated more damage than initially assumed.

An operation life indicator OLI equal to the quotient of updated statistical life value L_{10,USL} over a period of analysis and the first reference updated statistical life value L_{10,USL} is defined as the operation life indicator is defined.

$$OLI = \frac{{L}_{10 , USL}}{{L}_{10 , Ref}}$$

The operation life indicator OLI permits to determine the extent of the bearing damage.

To reduce the probability of failure of the bearing, the load applied on the bearing needs to be reduced.

The operating conditions may be modified to reduce damage accumulation.

The updated statistical life value permits to identify critical application conditions in order to increase the duration of the bearing and reduce unplanned downtime of the machine.

If at least one momentary life rating value is outside its domain of validity, the bearing is considered as defective.

For example, a short term violation of the speed limit of the bearing 5, a short term violation of the static load rating, a short term violation of the minimum load or the minimum speed might lead to a defect causing an immediate failure of the bearing 5 or leading to a failure after a short period of operation. Such events may be detected by measurements having values outside the range of measurements of the sensor, by calculation using a rating life model or by using a digital twin model of the machine 1. Events can be logged in an event log and mitigation action may be defined, in order to qualify or quantify the severity of the event.

The first and second determining means 8, 9 may further comprise a determination of a first sub updated statistical life value.

The first sub updated statistical life value is equal to the updated statistical life value determined over a first temporal interval having a predetermined length.

The comparison means 11 compare first sub updated statistical life value to a second reference updated statistical life value to determine the degree of accumulated damage of the bearing.

If the first sub updated statistical life value is lower than second reference updated statistical life value, the bearing is accumulating more damage than initially assumed.

The predetermined length is defined according to the application of the machine 1.

For example, the predetermined length is equal to one year for the wind turbine in order to take into account the seasonal effect of wind on the bearing.

The first and second reference updated statistical life values may be equal or different.

In variant, the first and second determining means 8, 9 may further comprise a determination of the first sub updated statistical life value and a second sub updated statistical life value.

The second sub updated statistical life value is equal to the updated statistical life value determined over a second temporal interval having the predetermined length.

The second temporal interval being subsequent to the first temporal interval.

The comparison means 11 compare first sub updated statistical life value to the second updated statistical life value to determine the relative degree of accumulated damage of the bearing.

What is claimed is:

1. A method for determining updated statistical life value of a bearing in a machine, the method comprising:
determining momentary life rating values from values of at least one parameter representative of the conditions of use of the bearing in the machine and from a rating life model of the bearing, and
determining the updated statistical life value from the momentary life rating values.

2. The method according to claim 1, further comprising determining an operation life indicator equal to the first reference updated statistical life value divided by a first reference updated statistical life value to determine the extent of bearing damage.

3. The method according to claim 1, wherein the values of the at least one parameter are represented by a temporal continuous signal, and wherein determining momentary life rating values comprises:
sampling each temporal continuous signal, each sampled temporal continuous signal being defined by a series of successive sampling intervals,
determining a discrete value for each sampling interval of each sampled temporal continuous signal, and
for each sampling interval, determining the momentary life rating value from the discrete value of the said sampling interval of each sampled temporal continuous signal and the rating life model.

4. The method according to claim 3, wherein if the sampling intervals of the series of successive sampling intervals of each sample temporal continuous signal have not the same length, the method further comprises weighting each momentary life rating value according to the length of the sampling interval associated to the said momentary life rating value.

5. The method according to claim 1, further comprising:
determining a first sub updated statistical life value, the first sub updated statistical life value being equal to the updated statistical life value determined over a first temporal interval having a predetermined length, and
comparing the first sub updated statistical life value to a second reference updated statistical life to determine the relative degree of accumulated damage of the bearing.

6. The method according to claim 1, further comprising:
determining a first sub updated statistical life value, the first sub updated statistical life value being equal to the updated statistical life value determined over a first temporal interval having a predetermined length,
determining at least a second sub updated statistical life value, the second sub updated statistical life value being equal to the updated statistical life value determined over a second temporal interval having the predetermined length, the second temporal interval being subsequent to the first temporal interval, and
comparing the first sub updated statistical life value and the second sub updated statistical life value to determine the relative degree of accumulated damage of the bearing.

7. The method according to claim 1, wherein if at least one momentary life rating value determined from values of the parameter and the rating life model is outside of its domain of applicability, the bearing is considered defective.

8. The method according to claim 2, wherein the values of the at least one parameter are represented by a temporal continuous signal, and wherein determining momentary life rating values comprises:
sampling each temporal continuous signal, each sampled temporal continuous signal being defined by a series of successive sampling intervals,
determining a discrete value for each sampling interval of each sampled temporal continuous signal, and
for each sampling interval, determining the momentary life rating value from the discrete value of the said sampling interval of each sampled temporal continuous signal and the rating life model.

9. The method according to claim 8, wherein if the sampling intervals of the series of successive sampling intervals of each sample temporal continuous signal have not the same length, the method further comprises weighting each momentary life rating value according to the length of the sampling interval associated to the said momentary life rating value.

10. The method according to claim 4, further comprising:
determining a first sub updated statistical life value, the first sub updated statistical life value being equal to the updated statistical life value determined over a first temporal interval having a predetermined length, and
comparing the first sub updated statistical life value to a second reference updated statistical life to determine the relative degree of accumulated damage of the bearing.

11. The method according to claim 10, further comprising:
determining a first sub updated statistical life value, the first sub updated statistical life value being equal to the updated statistical life value determined over a first temporal interval having a predetermined length,
determining at least a second sub updated statistical life value, the second sub updated statistical life value being equal to the updated statistical life value determined over a second temporal interval having the predetermined length, the second temporal interval being subsequent to the first temporal interval, and
comparing the first sub updated statistical life value and the second sub updated statistical life value to determine the relative degree of accumulated damage of the bearing.

12. The method according to claim 11, wherein if at least one momentary life rating value determined from values of the parameter and the rating life model is outside of its domain of applicability, the bearing is considered defective.

13. A device for determining updated statistical life value of a bearing in a machine, the device comprising:
a rating life model of the bearing,
a first determining means configured to determine momentary life rating values from values of at least one parameter representative of the condition of use of the bearing in the machine and the rating life model, and
a second determining means configured to determine the updated statistical life value from the momentary life rating values.

14. A wind turbine comprising a bearing and a device according to claim 13.
